(19) United States
(12) Patent Application Publication
(10) Pub. No.: US 2005/0095436 A1
(43) Pub. Date: May 5, 2005

(54) Synthetic based self seal adhesive system for packaging

(76) Inventor: Harold G. Story, Milwaukee, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/965,243

(22) Filed: Oct. 14, 2004

Related U.S. Application Data
(63) Continuation-in-part of application No. 10/254,695, filed on Sep. 25, 2002, now abandoned.
Application No. 10/254,695 is a continuation of application No. 09/099,177, filed on Jun. 18, 1998, now abandoned.

(51) Int. Cl. B32B 25/16; B32B 25/18; B32B 25/20; C08J 3/03

(52) U.S. Cl. 428/423.1; 428/447; 428/521; 428/522; 524/475

(57) ABSTRACT

The present invention provides a waterbased self seal adhesive system utilizing, a self seal adhesive containing no natural rubber. The self seal adhesive system is comprised of a transfer adhesive disposed on a transfer web and an anchor adhesive disposed on an anchor web with the two adhesives forming the seal for the package. The self seal adhesives bond to themselves when pressure is applied to close or seal the packaging material. When peeled apart, the adhesive splits, adhesively fails from either or both the front web or the back web, or destroys one or both of the substrates of the package. Primer coatings may also be used to enhance performance of the self seal adhesive.

### CROSS-REFERENCE TO RELATED APPLICATIONS

This application is a continuation-in-part of application Ser. No. 10/254,695 filed Sep. 25, 2002, now abandoned, which in turn is a continuation of application Ser. No. 09/099,177 filed Jun. 18, 1998, now abandoned.

### BACKGROUND OF THE INVENTION

The present invention relates to waterbased self seal adhesive packaging systems, and more particularly to a waterbase self seal adhesive flexible packaging system that utilizes a synthetic-based, self seal adhesive containing no natural latex that provides a bond between two substrates when sealed, but when peeled, the adhesive splits, adhesively fails from either or both the front web or the back web, or destroys one or both of the substrates of the package, thus preventing resealing of the packaging. Primer coatings may also be used to enhance the performance of the peelable self seal adhesive.

A self seal adhesive is a type of pressure-sensitive adhesive, which possesses the ability to form a strong bond to itself when pressure is applied and also to form a bond to the substrate on which it is applied. However, self seal adhesives preferably lack adhesion to surfaces such as plastic films and overprint varnishes which are on the opposite face of these flexible substrates so that such flexible substrates or webs bearing the self seal adhesives may be reeled into a roll for storage without blocking, i.e. without sticking together. Self seal adhesives are used in a variety of different types of applications, but are particularly desirable for use as sealants in packaging for food such as candies, chocolates, ice cream and the like which are sensitive to heat thus rendering undesirable the use of heat sealable adhesives to seal such packages.

Typical self seal adhesives have been formulated by combining a natural rubber elastomer, particularly a latex, with a tackifier and other ingredients such as stabilizers, antioxidants, and other conditioning agents. Natural rubber elastomers exhibit most of the desirable self sealing properties. However, natural rubber-based adhesives also exhibit poor aging properties such as discoloration, and may also possess objectionable odor. In addition, natural rubber-based adhesives containing natural latex have a variety of naturally occurring substances such as plant proteins which can cause allergic reactions in people.

A number of attempts have been made to develop a synthetic self seal, i.e. one that does not contain any natural latex. These approaches vary in the chemistry used. For example:

U.S. Pat. No. 4,810,745, assigned to Century Adhesives Corp. describes both a natural latex based self seal and one comprised of a styrenic block copolymer emulsion (25 to 45%), an acrylic polymer (20 to 25%), a tackifier (25 to 35%), and vinylpyrolidone/styrene copolymer.

U.S. Pat. No. 4,889,884, assigned to National Starch and Chemical Corp. describes a formulation comprised of four synthetic polymers, i.e. the first comprised of butyl acrylate, 2-ethyl hexyl acrylate, and vinyl acetate (T_{g}=54° C., Williams Plasticity of 2.7), the second comprised of medium styrene content acrylic resin (T_{g}=−18° C., Williams Plasticity of 5.1), a third comprised of butyl acrylate, vinyl acetate, acrylic acid, and N-methylolacrylamide (T_{g}=−2° C., Williams Plasticity of 5.3), and a fourth comprised of a high styrene acrylic resin (T_{g}=+6° C.). As alternatives for the fourth resin the following could be used: medium styrene content acrylic resin, a low ethylene vinyl acetate resin, a medium ethylene vinyl acetate resin, or a vinyl acrylic resin containing acid and N-methylolacrylamide.

U.S. Pat. No. 4,898,787, assigned to Mobil Oil Corp., describes a formulation comprised of two synthetic polymer emulsions. The primary synthetic emulsion (45 to 70% of the formulation), has a T_{g} of −60° C. to −40° C. and a Williams Plasticity Number of 2.5 to 2.9, and a secondary styrene acrylic emulsion (30 to 55% of the formulation), has a T_{g} of −25° C. to +5° C., and a Williams Plasticity Number of 5.0 to 5.6.

U.S. Pat. No. 5,070,164, assigned to Mobil Oil Corp., describes an acrylic terpolymer for cold sealable packaging. The terpolymer is made from a first monomer selected from the group of ethyl acrylate, hexyl acrylate, isoctyl acrylate, butyl acrylate, methyl acrylate and vinylidene chloride, a second monomer selected from the group of vinyl acetate, methyl methacrylate, styrene, ethyl methacrylate, and isobutyl methacrylate and a third monomer selected from the group of methacrylic acid, acrylic acid, itaconic acid, sulfoethyl methacrylate, and malic acid with an additional condition, that each of the first, second and third monomers are different.

U.S. Pat. No. 5,486,426, assigned to Mobil Oil Corp., describes an acrylic copolymer composition, polymerized using an acrylonitrile from 10 to 65%, a soft monomer (acrylate esters from methyl to isooctyl or vinyl acetate) from 30 to 85%, and an acid third monomer (methacrylic acid, acrylic acid, crotonic, itaconic acid, sulfoethyl methacrylate, and maleic acid) from 1 to 3%, such that the resulting polymer has a T_{g} of −35° C.

The above attempts to replace natural rubber with synthetic adhesives to alleviate the problems associated with natural rubber has proven to be difficult because of the poor performance of the resultant bonds. Accordingly, there remains a need for an improved self seal adhesive system containing no natural rubber which exhibits the desired attributes noted above.

### SUMMARY OF THE INVENTION

The present invention relates to a waterbased self seal adhesive for a packaging system, and to the package formed thereby. More particularly, the present invention provides a waterbased self seal adhesive flexible packaging system that utilizes a synthetic-based, self seal adhesive containing no natural latex that provides a bond between two substrates when sealed, but when peeled, the adhesive splits, adhesively fails from either or both the front web or the back web, or destroys one or both of the substrates of the package, thus preventing resealing of the package, called a “peelable.” Primer coatings located between the adhesive and the substrates may also be used to enhance the performance of the peelable self seal adhesive system by either increasing or decreasing the adhesion of the adhesives to the substrates.

In order to accomplish the above, the present invention provides a flexible substrate anchor web having an exterior surface and an interior surface, a flexible substrate transfer web having an exterior surface and an interior surface with the interior surface adapted to combine with the interior surface of the anchor web to form a package to contain an article. The self seal adhesive system utilized with such a package includes a non-natural rubber containing anchor adhesive applied over a first area of the interior surface of the anchor web, a non-natural rubber-containing transfer adhesive applied over a second area of the interior surface of the transfer web so that the first and second areas are disposed in registry when the anchor and transfer webs combine to form the package. When the anchor web and transfer web are combined, the first and second areas align and the anchor adhesive and transfer adhesive bond to one another to form a seal for the package. In one particularly preferred application, the self seal adhesive system of the present invention is used to form the end seals and the fm seal for individually packaged food items such as candy wrappers.

In the peelable system, after sealing, it is essential that the transfer front web adhesive has a balanced affinity between the anchor (back) adhesive and the substrate of the transfer (front) web. In many end uses, the terms front and back are substituted for transfer and anchor respectively. It is also essential that the anchor (back) adhesive has a balanced affinity between the transfer (front) adhesive and the substrate of the anchor (back) web. This is measured by the peel strength of the adhesive, and its failure mode, when peeling in a T-peel configuration. To those skilled in the art, types of failure modes include, but are not limited to: cohesive failure, cohesive split, adhesive split, adhesive failure to one substrate or the other (clean peel), etc. The preferred transfer (front) or anchor (back) substrate is, but not limited to, polyolefin or metallized polyolefin films.

The transfer (front) and anchor (back) adhesives are formulated to contain no natural rubber, but instead contain about 50% to 90% by weight of an elastomer emulsion or blend of elastomer emulsions having a combined Tg of about −25° C. to about −35° C., and about 10% to 50% by weight of a polymer emulsion or blend of polymer emulsions having a combined Tg of about +15° C. to about +25° C. The elastomer emulsion preferably contains an elastomer selected from: styrene-isoprene-styrene, styrene-butadiene-styrene, styrene-ethylene-butylene-styrene, ethylene-vinylacetate, amorphous polyalpha-olefin, styrene-butadiene rubber, acrylics, acrylic copolymers, EPDMs, butyl, polybutadienes, polychloroprene, silicones, synthetic polyisoprene and/or combinations of these elastomers. The elastomer emulsion and polymer emulsion are formulated with various other compounds and/or polymers, such as plasticizers, pH adjusters antiblocking/anticling additives, defoamers and other additives. The preferred elastomers in the elastomer emulsion are styrene-butadiene rubber and acrylic rubber, and the preferred polymer in the polymer emulsion is a styrene acrylate. The relatively high Tg for the elastomer emulsion as well as the relatively high Tg for the polymer emulsion in the formulation of the present invention provides an adhesive composition that has better adhesion, better peel strength and better blocking resistance than an adhesive such as that described in U.S. Pat. No. 4,898,787.

An anchor (back) primer on the interior surface of the anchor (back) web and/or a transfer (front) primer coating on the interior surface of the transfer (front) web may also be utilized to either enhance or decrease adhesion of the adhesives to the webs. If utilized to enhance adhesion, the primer coating comprises about 2 to 99.9% by weight of a polymer or combination of polymers selected from: styrene butadiene rubber (SBR), acrylic polymers and copolymers, ethylene vinyl acetate (EVA), ethylene methacrylic (EMA) or acrylic acid (EAA), polyethyleneimine (PEI), polyurethane (PU), silanes and silanated polymers. The rest of the composition to be comprised of modifiers and water. If utilized to decrease adhesion, the primer coating comprises about 5 to 99% by weight of a polymer selected from: a high molecular weight polyethylene polymer or ethylene copolymer, SIS, SBS, SEBS, SBR, acrylics, silicone, or any other polymer base that, when formulated with the appropriate ingredients, can provide enhanced release from one or both of the webs.

In one embodiment, the anchor (back) adhesive and transfer (front) adhesive have different formulations, and the anchor (back) and transfer (front) webs are separate substrates, each composed of different materials. In another embodiment, the anchor (back) and the transfer (front) adhesive have different formulations, but the anchor (back) and transfer (front) web are both part of the same substrate and composed of the same material. In a third embodiment, the anchor (back) and the transfer (front) adhesives have substantially the same formulation, but the anchor (back) and the transfer (front) web are composed of different materials. In a fourth embodiment, the anchor adhesive and the transfer adhesive have essentially the same formulation, but the anchor (back) and transfer (front) web are both part of the same substrate and composed of the same material. In any of the above embodiments, primer coatings having the same or different formulations may be used if needed or desired.

### DETAILED DESCRIPTION OF THE INVENTION

The present invention relates to waterbased self seal adhesive packaging systems, and more particularly to a water based self seal adhesive flexible packaging system that utilizes a synthetic-based, self seal adhesive containing no natural latex that provides a bond between two substrates when sealed, but when peeled, the adhesive splits, adhesively fails from either or both the front web or the back web, or destroys one or both of the substrates of the package, called a “Peelable,” thus preventing resealing of the package. Primer coatings located between the adhesive and the substrates may also be used to enhance the performance of the self seal adhesive system by either increasing or decreasing the adhesion of the adhesives to the substrates. The packaging material can be utilized to wrap and seal various types of products, such as food products like candy and other comestibles, or sterile medical devices such as syringes, tubing, gloves, bandages and the like. Although food products and medical devices may be the preferred articles wrapped by the present self seal adhesive system, the present disclosure is not limited to such packages, but instead may be utilized with other forms of packaging for containing both comestible as well as non-comestible products.

The creation of a package typically begins with the production of a continuous sheet or web of wrapping material. The continuous web of material is generally in the form of a thin, flexible film, and as is conventional, proceeds generally horizontally downstream to multi-station printing presses where artwork and text in one or more colors is applied to its exterior surface, and adhesive in applied to its interior surface in either a predetermined pattern or overall coverage. The adhesive pattern typically will be rectangular defined by a pair of longitudinal strips along opposite edges of the web and a transverse strip extending between the two longitudinal strips. The distance between the transverse strips of adhesive define the length of the particular wrapper. The adhesive layer is typically applied to the interior surface of the web after the application of the artwork and text on the exterior of the web by Gravure roll application, or by any other conventional means, so that the layer of adhesive has a thickness of about 0.05 to about 1.0 mil and may consist of either a multitude of separate spots or dots or a solid continuous layer. Also, it is typical for a protective surface, such as an overprint varnish or a release film, to be applied over the artwork and text to protect the artwork and text from smudging, and to increase the coefficient of friction of the exterior surface of the web. As is conventional, the adhesive is applied in lengthwise and widthwise strips in the appropriate surface areas of the web to form a rectangular configuration so that after insertion of the article to be wrapped, the web may be folded so that the longitudinal and transverse strips of adhesive register with one another and become aligned so that upon the application of pressure, the web forms the shape, size and volume with the package desired. The transverse strips of adhesive will form an end seal while the longitudinal strips of adhesive will form a fin seal for the package.

As noted above, the web itself is generally preferred to be formed as a thin, flexible material to function as a substrate for the materials to be applied. The web itself may be made of a plastic film material such as polyethylene, polypropylene, polyesters, polyolefins, polystyrene, nylon, polycarbonates, cellophane, ethylenevinyl acetates, ethylenevinyl alcohols, polyvinyl alcohols, polyvinyl chloride, alphaolefins, polyvinyl butyrate, cellulose acetate, butyrate or cellulose acetate propionate or metallized versions of any of the aforementioned films. Alternately, depending upon the article to be packaged, the web may be made of a metalize foil such as aluminum foil, or the metalized foil may be laminated to the web. Another alternative, especially for use in connection with medical devices, is for one or more webs to be formed of paper and paper products, including paperboard such as containerboard, which includes corrugating medium and linerboard used to make corrugated paper, and boxboard used to make folding cartons. In addition, paper products such as publication grade paper or bleached or unbleached kraft paper, or recycled paper may also be utilized. The above paper products may also be clay-coated to enhance printing of the artwork and text.

In the packaging of food products such as candy, it is desirable to provide a peelable closure system. In order to provide a peelable closure for the packaging material, the present invention provides a synthetic-based self seal adhesive system containing no natural rubber. The system is comprised of a transfer adhesive applied to a transfer web and an anchor adhesive applied to an anchor web. Regardless of what is being packaged, it should be noted that the anchor web and transfer web, as described herein, are typically both part of the same substrate and composed of the same material. However, the anchor web and transfer web may be separate substrates and each may be composed of a different material depending upon the particular packaging material desired and the article to be wrapped. In any event, the anchor adhesive and transfer adhesive, which also may be either the same or different formulations, must have sufficient affinity for each other and for the webs so that when a sealing pressure appropriate for the marketplace, typically 60 to 100 pounds per linear inch for confectionery, is applied thereto, the two adhesives bond to each other and to the webs to form a closure or seal for the packaging material and thus contain or wrap the article inside.

In all peelable self seal systems, the acceptable mode of failure is determined by the market in which the self seal will be sold. Modes of failure include but are not restricted to, cohesive failure, cohesive split, adhesive failure, film or paper destruct, etc.

It is important to note that the self seal adhesives utilized in the present system contains no natural rubber. As used herein, the term “natural rubber” includes all materials made from or containing natural latex. The term “natural latex” as used herein is defined as a milky fluid that consists of extremely small particles of rubber obtained from plants, principally from the H. brasiliensis (rubber) tree dispersed in an aqueous medium. It contains a variety of naturally occurring substances, including cis-1,4-polyisoprene in a colloidal suspension and plant proteins which are believed to be the primary allergen. Products that contain natural rubber are made using two commonly employed manufacturing processes, namely, the natural rubber latex (NRL) process, and the dry natural rubber (DNR) process.

The peelable adhesive composition of the present invention includes about 50% to about 90% by weight of an elastomer polymer emulsion or blend of elastomer polymer emulsions having a Tg of −25° C. to −35° C., preferably −28° C. to −32° C., and most preferably about −30° C.; about 10% to about 50% by weight, of a polymer emulsion or blend of polymer emulsions having a Tg of +15° C. to +25° C. preferably +18° C. to +22° C., and most preferably about +20° C.; about 0% to about 30% by weight, of a suitable conditioning additive; about 0% to about 3% by weight, of an antioxidant/stabilizer; and about 0% to about 30% preferably about 0.5 to 10% by weight of a plasticizer; the components of the composition adding up to 100% by weight. The relatively high Tg for the elastomer emulsion as well as the relatively high Tg for the polymer emulsion in the formulation of the present invention provides an adhesive composition that has better adhesion, better peel strength and better blocking resistance than an adhesive such as that described in U.S. Pat. No. 4,898,787.

The components of a suitable peelable adhesive composition are as follows:

| Ingredient | % by weight |
|---|---|
| Synthetic Elastomer or blend of Elastomers having a | 50 to 90, |
| combined Tg of −25° C. to −35° C. | Preferably 60 to 80 |
| A polymer emulsion or blend of emulsions having a | 10 to 50, |
| combined Tg of +15° C. to +25° C. | Preferably 15 to 30 |
| Plasticizer | 0 to 30 |
| pH adjuster(s) | 0 to 5 |
| Stabilizer(s) | 0 to 3 |
| Defoamer(s) | 0 to 3 |
| Anti-blocking/Anti-cling additive(s) | 0 to 20 |
| Other conditioning additives | 0 to 5 |

It should be noted that the self seal adhesives must come in contact with each other and be sealed with adequate pressure to ensure that a seal is obtained. These pressures range from 0.5 to 80 psi and are tested with a dwell time of 0.05 to 10 seconds. It should also be noted that the coat weights of these self seal adhesives range from 0.1 to 5.0 pounds dry per 3,000 ft².

The preferred elastomer polymer in the elastomer emulsion part of this peelable adhesive composition is, but not limited to, either SBR (Styrene Butadiene Rubber) or an Acrylic Elastomer. Other elastomers useful in the compositions include, but are not limited to, other acrylics, acrylic copolymers, isoprenes such as SIS (styrene-isoprene-styrene) and synthetic polyisoprene, polybutadienes such as SBS (styrene-butadiene-styrene), styrene block copolymers such as SEBS (styrene-ethylene-butylene-styrene), polychloroprenes, EPDMs (ethylene-propylene rubbers), butyls, EVA (ethylene-vinyl acetate), APAOs (amorphous polyalpha-olefins), and silicones, and/or combinations of these elastomers. The most preferred amount of elastomer is from 70-85% by weight.

The preferred polymer in the polymer emulsion part of this formulation is, but not limited to, a carboxylated vinyl acetate ethylene emulsion or a styrene acrylate emulsion. Other polymer emulsions include, but are not limited to, acrylates, styrene acrylates, vinyl acetates, vinyl acetate ethylene copolymers, ethylene vinyl acetate copolymers, (high styrene) styrene butadiene rubbers, polyurethane dispersions, polystyrene emulsions, vinyl chloride ethylene emulsions, polyvinyl chloride homopolymer and copolymer emulsions, polyvinylidene chloride homopolymer and copolymer emulsions, polyethylene homopolymer and copolymer emulsions, polypropylene homopolymer and copolymer emulsions, and polyester emulsions, and/or combinations of these polymers.

The plasticizer may comprise 0 to 30%, preferably about 0.5 to 10%, by weight of the composition. It is important that the plasticizer be miscible with the polymer emulsion and/or the elastomer emulsion. Plasticizers of this type are: benzoate esters, phthalate esters, sebacate esters, adipate esters, acrylic esters, glycolate esters, citrate esters, aromatic oils, napthenic oils, paraffinic oils, oligomeric polyesters, lactates, liquid rosin esters, glycerates, and other monomeric, oligomeric or polymeric esters, or oils.

It is desirable that the plasticizer be preferably miscible with the polymer emulsion and be alkali soluble. Plasticizers of this type are: Carboset 515 supplied by BF Goodrich Specialty Chemicals, low molecular weight acrylic or acrylic copolymers having acid numbers between 25 and 250, low molecular weight olefin copolymers having acid numbers between 25 and 250, liquid rosin esters having acid numbers between 25 and 250, and other low molecular weight liquid polymers having acid numbers between 25 and 250.

The present invention includes a stabilizer or antioxidant in an amount of from 0% to 3% by weight, preferably from about 0.1% to 3% by weight, but most preferably from about 0.5% to 2%. The stabilizers which are useful in the self seal adhesive composition of the present invention are incorporated to help protect the polymers noted above, and thereby the total adhesive system, from the effects of thermal and oxidative degradation which normally occurs during the application of the adhesive as well as in the ordinary exposure of the final product to the ambient environment and sterilization procedures. Such degradation is usually manifested by a deterioration in the appearance, physical properties and performance characteristics of the adhesive. Among the preferred antioxidants are Butyl Zimate, a zinc dibutyldithiocarbamate, and Irganox 1010, a tetrakis(methylene(3,5-di-teri-butyl-4-hydroxyhydrocinnnamate))methane manufactured by Ciba-Geigy. Among the applicable stabilizers are high molecular weight hindered phenols and multifunctional phenols, such as sulfur and phosphorus-containing phenols. Hindered phenols are well known to those skilled in the art and may be characterized as phenolic compounds which also contain sterically bulky radicals in close proximity to the phenolic hydroxyl group thereof. In particular, tertiary butyl groups generally are substituted onto the benzene ring in at least one of the ortho positions relative to the phenolic hydroxyl group. The presence of these sterically bulky substituted radicals in the vicinity of the hydroxyl group serves to retard its stretching frequency and correspondingly, its reactivity; this steric hindrance thus providing the phenolic compound with its stabilizing properties. Representative hindered phenols include:

1,3,5-trimethyl-2,4,6-tris(3-5-di-tert-butyl-4-hydroxbenzyl) benzene;

pentaerythritol tetrakis-3(3,5-di-tert-butyl-4-hydroxyphenyl) propionate;

n-octadecyl-3(3,5-ditert-butyl-4-hydroxyphenyl) propionate;

4,4′-methylenebis(4-methyl-6-tert butylphenol);

4,4′-thiobis(6-tert-butyl-o-cresol);

2,6-di-tert-butylphenol;

6-(4-hydroxyphenoxy)-2,4-bis(n-ocytlthio)-1,3,5-triazine;

2,4,6-tris(4-hydroxy-3,5-di-tert-butyl-phenoxy)-1,3,5-triazine; di-n-octadecyl-3,5-di-tert-butyl-4-hydroxybenzylphosphonate;

2-(n-octylthio)ethyl-3,5-di-tert-butyl-4-hydroxybenzoate; and

sorbitol hexa-(3,3,5-di-tert-butyl-4-hydroxy-phenyl) propionate.

Preferred as a stabilizer is pentaerythritol tetrakis-3(3,5-di-tert-butyl-4-hydroxyphenol) propionate. Most preferred are the carbamates, such as Butyl Zimate, and various other sulfur containing compounds, etc. Most preferred for this invention is that the antioxidants are dispersions, emulsions, or solutions in water.

The performance of these stabilizers may be further enhanced by utilizing, in conjunction therewith; (1) synergists such as, for example, as thiodipropionate esters and phosphites; and (2) chelating agents and metal deactivators as, for example, ethylenediaminetetraacetic acid, salts thereof, and disalicylalpropylenedimine.

The adhesive composition useful in the method of the present invention may be formulated using any of the techniques known in the art. A representative example of the prior art procedure involves placing the ingredients one by one into a stainless steel mixing vessel, while providing enough agitation to ensure proper and effective mixing of the ingredients. After all the ingredients have been added, the adhesive batch is adjusted to meet its critical physical parameters.

Optional conditioning additives may be incorporated into the adhesive composition in order to modify particular physical properties. These additives may include colorants, such as titanium dioxide, defoamers, sequestrants, deionized water, preservatives, biocides, anti-blocking agents, anti-cling agents, pH adjusters, surfactants and other commonly known and used additives. As noted above, such additives can be present in amounts ranging from 0% to about 30% by weight.

Anti-blocking/anti-cling agents may also be incorporated into the adhesive composition in amounts ranging from 0% to 20% by weight, preferably 0% to 10% by weight. These are inert in the formulation, and include materials such as hydrated alumnina (Al₂O₃-3H₂O), silicates such as magnesium silicates, aluminum silicate, sodium silicate, potassium silicate and the like, mica, calcium carbonate (CaCO₃) and silica. Other commonly employed materials such as fillers may also be used as long as they do not materially alter the function of the remaining ingredients in the formulation.

As previously noted, the system may also include a primer coating applied as a thin film on the interior surface of the anchor and/or transfer web to enhance adhesion of the adhesive to one or both webs. This primer coating comprises about 2 to 99.9% of a polymer or combination of polymers, selected from: styrene butadiene rubber (SBR), acrylic polymers and copolymers, ethylene vinyl acetate (EVA), ethylene methacrylic (EMA) or acrylic acid (EAA), polyethyleneimine (PEI), polyurethane (PU), silanes and silanated polymers. This primer coating preferably comprises 90% by weight of a SBR.

The system may also include a primer coating applied as a thin film on the interior surface of the anchor and/or transfer web to decrease adhesion of the adhesive to one or both webs. This primer coating preferably comprises about 5 to 99.9% by weight of a high molecular weight (i.e. molecular weight greater than 40,000) polyethylene polymer or copolymer. However, this primer coating may be a SIS, SBS, SEBS, SBR, acrylics, silicone, a PVAc (polyvinyl acetate), an EVA (ethylene-vinyl-acetate), PE (polyethylene), PP (polypropylene), EAA (ethylene acrylic acid), EMAA (ethylene methacrylic acid), EEA (ethylene-ethyl acrylate), EMAC (ethylene-methyl acrylate), EVOH (ethylene-vinyl alcohol), or any of these blended with a synthetic elastomer as previously defmed herein, and/or other materials to enhance release or stability.

In a peelable self-seal adhesive system, the transfer adhesive and anchor adhesive may have substantially the same formulation, and be preferably comprised of:

about 60 to 80% by weight of a styrene-butadiene elastomer emulsion or acrylic rubber emulsion having the described Tg;

about 15 to 30% by weight of a styrene-acrylate polymer emulsion having the described Tg ;

about 0.5 to 10% by weight of a plasticizer;

about 0.5 to 2% by weight of antiblocking/anticling additives; and

about 0.1 to 10% by weight of defoamers, pH adjusters, stabilizers, antioxidants and other additives; the components totaling 100% by weight of said adhesive.

It is important that the self seal system processes in the customer's equipment and releases from the back side of the roll when wound on a roll core.

Examples of the peelable system are as follows:

### EXAMPLE 1

| Material | Amount in % | Description |
|---|---|---|
| Rovene 4020 | 75.4 | Styrene Butadiene Rubber |
| By Mallard Creek | | Tg = −30 deg. C. |
| Polymers | | |
| Hycar 26288 | 16.8 | Styrene Acrylate polymer |
| By Noveon Corp. | | Tg = +20 deg. C. |
| Carboset 515 | 1.2 | Alkali soluble Acrylic |
| By Noveon Corp. | | Plasticizer Tg = |
| | | −14 deg. C. |
| Lo-Vel 29 | 1 | Anti-blocking additive |
| By A.E. Fleming Co. | | |
| Michemlube 156F | 0.4 | Anti-blocking additive |
| By Michaelmen | | |
| Dee-Fo 97-2 | 0.2 | DeFoamer |
| By Ultra Additives | | |
| Aqueous Ammonia | 0.6 | PH Adjuster |
| (Ammonium Hydroxide) | | |
| Water | 4.4 | Viscosity Adjusting |
| | | Additive |

### EXAMPLE 2

| Material | Amount in % | Description |
|---|---|---|
| Carbotac XPD-1814 | 65.3 | Acrylic Rubber |
| By Noveon | | Tg = −30 deg. C. |
| Hycar 26288 | 27.4 | Styrene Acrylate Polymer |
| By Noveon Corp. | | Tg = +20 deg. C. |
| Hystretch V-43 FDA | 5.3 | Acrylic Rubber |
| By Noveon Corp. | | Tg = −43 deg. C. |
| Lo-Vel 29 | 1 | Anti-blocking Additive |
| By A.E. Fleming Co. | | |
| Dee Fo 97-2 | 0.6 | DeFoamer |
| By Ultra Additives | | |
| Aqueous Ammonia | 0.4 | PH Adjuster |
| (Ammonium Hydroxide) | | |

To assess the utility of the self seal adhesives in various packaging applications, the synthetic adhesives disclosed in Examples 1 and 2, were applied to a representative commercially available substrate film at a coat weight of 2.0 pounds per 3,000 ft² ream, +/−0.2 pounds per 3,000 ft² ream, using a #5 wire wound rod. All samples were sealed on a TMI^{R} SuperSealer™ Model #75-10, set at 0.5 second dwell, room temperature, and 80 psi over a 1 by 4 inch sample. All samples were peeled in a “T-Peel” mode at 12 inches per minute.

In Table 1 below, Example 1 and Example 2 are compared to product C1380-01, a natural latex containing self seal manufactured by Bostik Findley, Inc.

All products were coated onto “MLB 50 gage” polypropylene film manufactured by AET (Advanced Extrusion Technologies, Inc.), and blocked to “RLS-60 gage” polypropylene film manufactured by AET (Advanced Extrusion Technologies, Inc.).

All products were blocked as coated MLB to RLS in a Kohler Block Tester for 16 hours, at 100 psi at either RT (Room Temperature) or 122 deg. F. The samples were then removed from the block tester and allowed to equilibrate for 1 hour. Then the samples were evaluated for release in an I-Mass™ Peel tester at 12 inches per minute.

In evaluating acceptable results, the following guidelines were used:
Minimum Peel Strength: approximately equal to C1380-01
Peak Peel Strength: >or=to 300 grams
Release Value after aging at RT: <100 grams

Release Value after aging at 122 deg. F.: <100 grams

TABLE 1

| Test Parameter | Example 1 | Example 2 | C1380-01 |
|---|---|---|---|
| Minimum Peel Strength in | 280 | 233 | 240 |
| grams | | | |
| Peak Peel Strength in grams | 425 | 340 | 380 |
| Release Value, after aging at | 28 | 26 | 22 |
| RT for 16 hours at 100 psi, in | | | |
| grams | | | |
| Release Value, after aging at | 45 | 18 | 60 |
| 122 deg. F. for 16 hours at 100 psi, | | | |
| in grams | | | |

As can be seen both Examples 1 and 2 meet or exceed the performance of natural latex containing self seals, with acceptable seal strengths, release and mechanical stability properties being exhibited. As stated earlier, the application of synthetic self seals are not limited to the substrate combination disclosed herein.

### EXAMPLE 3

| Material | Amount in % | Description |
|---|---|---|
| Carbotac XPD-1814 | 75.8% | Acrylic Rubber |
| By Noveon Corp. | | Tg = −30° C. |
| E4000 | 18.9% | Styrene Acrylate Polymer |
| By Resolution Specialty | | Tg = +20° C. |
| Water | 3.4% | Viscosity adjusting |
| | | additive |
| Lo-Vel 29 | 0.8% | Anti-Blocking Additive |
| By A.E. Fleming Co. | | |
| Aqueous Ammonia | 0.6% | PH Adjuster |
| By Hydrite Chemical Co. | | |
| Rhodoline 999 | 0.3% | Anti-foam |
| By Rhodia, Inc. | | |
| Aerosol MA80-I | 0.2% | Wetting Agent |
| By Cyctec Industries, | | |
| Inc. | | |

The same tests were run on the formulation of Example 3 to assess its utility as a seal adhesive. The results are set forth in Tables 2 and 3.

TABLE 2

| Submitted | Coat Weight | | |
|---|---|---|---|
| Trail Rolls | Dry | Peak Cling Strength | Peak cling Strength |
| Identification | lb/Ream | RT Blocking Test | Oven Blocking Test |
| Example 3 | 2.8 | 60 g/inch | 53 g/inch |
| All Synthetic | | | |
| (invention) | | | |
| C2881 | 3.0 | 69 g/inch | 72 g/inch |
| Natural Rubber | | | |
| Based Self | | | |
| Seal | | | |
| By Bostik, Inc. | | | |

TABLE 3
Test Results: Average seal strengths of trail rolls. RH in testing lab was 50%.

| | | Initial | 2 Week | 3 Week | 4 Week | 5 Week | 6 Week |
|---|---|---|---|---|---|---|---|
| | | Average | Average | Average | Average | Average | Average |
| Trial Rolls | | Strength | Strength | Strength | Strength | Strength | Strength |
| Example 3 | End | AF/459 g | AF/436 g | AF/482 g | AF/466 g | AF/450 g | AF/477 g |
| | Seal | SD-25 | SD-10 | SD-14 | SD-12 | SD-18 | SD-15 |
| All Synthetic | Fin | AF/451 g | AF/446 g | AF/530 g | AF/462 g | AF/443 g | AF/458 g |
| | Seal | SD-16 | SD-25 | SD-22 | SD-25 | SD-11 | SD-21 |
| C2881 | End | AF/483 g | AF/451 g | AF/490 g | AF/491 g | AF/471 g | AF/482 g |
| | Seal | SD-16 | SD-8 | SD-8 | SD-24 | SD-9 | SD-14 |
| Natural | Fin | AF/502 g | AF/437 g | AF/512 g | AF/489 g | AF/519 g | AF/502 g |
| Rubber | Seal | SD-11 | SD-19 | SD-13 | SD-15 | SD-26 | SD-16 |
| Based | | | | | | | |

AF = Adhesive Failed
SD = Standard Deviation
RH = Relative Humidity
RT = Room Temperature

The data in Tables 2 and 3 demonstrate that the formulation of Example 3 performs admirably as a peelable self seal adhesive. It has acceptable seal strength of greater than 300 g (Table 3) and adequate release strength of less than 100 g (Table 2).

1. A water based non-natural rubber containing self seal adhesive composition comprised of:
about 50% to 90% by weight of an elastomer emulsion or blend of elastomer emulsions having a combined Tg of about −25° C. to about −35° C.;
about 10% to 50% by weight of a polymer emulsion or blend of polymer emulsions having a combined Tg of about +15° C. to about +25° C.;
about 0 to 30% of a plasticizer; and
about 0 to 30% of a conditioning additive;
the components totaling 100% by weight of said additive.

2. The adhesive system of claim 1 wherein said elastomer emulsion contains a polymer or copolymer selected from the group consisting of styrene-isoprene-styrene, styrene-butadiene-styrene, styrene-ethylene-butylene-styrene, ethylene-vinylacetate, amorphous polyalpha-olefin, styrene-butadiene rubber, acrylics, acrylic copolymers, EPDMs, butyl, polybutadienes, polychloroprene, silicones, synthetic polyisoprene and/or combinations of these elastomers.

3. The adhesive system of claim 1 wherein said polymer emulsion contains a polymer or copolymer selected from the group consisting of: carboxylated vinyl acetate ethylene emulsion, styrene acrylate emulsion and acrylates, styrene acrylates, vinyl acetates, vinyl acetate ethylene copolymers, ethylene vinyl acetate copolymers, (high styrene) styrene butadiene rubbers, polyurethane dispersions, polystyrene emulsions, vinyl chloride ethylene emulsions, polyvinyl chloride homopolymers and copolymers emulsions, polyvinylidene chloride homopolymers and copolymer emulsions, polyethylene homopolymer and copolymer emulsions, polypropylene homopolymer and copolymer emulsions, and polyester emulsions, and/or mixtures thereof.

4. The adhesive system of claim 1 wherein said adhesive is comprised of:
about 60 to 80% by weight of an elastomer emulsion containing an elastomer selected from the group consisting of a styrene-butadiene elastomer, an acrylic rubber elastomer, and blends thereof;
about 15 to 30% by weight of a styrene-acrylate polymer emulsion;
about 0.5 to 10% by weight of a plasticizer;
about 0.5 to 2% by weight of antiblocking/anticling additives;
about 0.1 to 10% by weight of other conditioning additives; the components totaling 100% by weight of said adhesive.

5. The adhesive of claim 1 wherein said conditioning additive is selected from the group consisting of defoamers, biocides, anti-blocking agents, anti-cling agents, pH adjusters, deionized water, colorants, sequestrants, preservatives and surfactants.

6. The adhesive of claim 1 wherein said elastomer emulsion contains an elastomer selected from the group consisting of a styrene-butadiene elastomer, an acrylic rubber elastomer, and blends thereof.

7. The adhesive of claim 1 wherein said polymer emulsion is a styrene-acrylate emulsion.

8. The adhesive of claim 1 wherein said plasticizer is selected from the group consisting of esters, oils and blends thereof.

9. The adhesive system of claim 4 wherein said elastomer emulsion or blend of elastomer emulsions has a combined Tg of about −28° C. to about −32° C.

10. The adhesive system of claim 4 wherein said polymer emulsion or blend of polymer emulsions has a combined Tg of about +18° C. to about +22° C.

11. A package for containing an article, said package comprising:
a flexible anchor web;
a flexible transfer web; and
a water based non-natural rubber containing self seal adhesive coated on a surface of either or both of said anchor and transfer webs, said adhesive comprises
about 50% to 90% by weight of an elastomer emulsion or blend of elastomer emulsions having a combined Tg of about −25° C. to about −35° C.;
about 10% to 50% by weight of a polymer emulsion or blend of polymer emulsions having a combined Tg of about +15° C. to about +25° C.;
about 0 to 30% of a plasticizer; and
about 0 to 30% of a conditioning additive;
the components totaling 100% by weight of said additive.

12. The package of claim 11 wherein said elastomer emulsion contains a polymer or copolymer selected from the group consisting of styrene-isoprene-styrene, styrene-butadiene-styrene, styrene-ethylene-butylene-styrene, ethylene-vinylacetate, amorphous polyalpha-olefin, styrene-butadiene rubber, acrylics, acrylic copolymers, EPDMs, butyl, polybutadienes, polychloroprene, silicones, synthetic polyisoprene and/or combinations of these elastomers.

13. The package of claim 11 wherein said polymer emulsion contains a polymer or copolymer selected from the group consisting of: carboxylated vinyl acetate ethylene emulsion, styrene acrylate emulsion and acrylates, styrene acrylates, vinyl acetates, vinyl acetate ethylene copolymers, ethylene vinyl acetate copolymers, (high styrene) styrene butadiene rubbers, polyurethane dispersions, polystyrene emulsions, vinyl chloride ethylene emulsions, polyvinyl chloride homopolymers and copolymers emulsions, polyvinylidene chloride homopolymers and copolymer emulsions, polyethylene homopolymer and copolymer emulsions, polypropylene homopolymer and copolymer emulsions, and polyester emulsions, and/or mixtures thereof.

14. The package of claim 11 wherein said adhesive is comprised of:
about 60 to 80% by weight of an elastomer emulsion containing an elastomer selected from the group consisting of a styrene-butadiene elastomer, an acrylic rubber elastomer, and blends thereof;
about 15 to 30% by weight of a styrene-acrylate polymer emulsion;
about 0.5 to 10% by weight of a plasticizer;
about 0.5 to 2% by weight of antiblocking/anticling additives;
about 0.1 to 10% by weight of other conditioning additives; the components totaling 100% by weight of said adhesive.

15. The package of claim 11 wherein said conditioning additive is selected from the group consisting of defoamers, biocides, anti-blocking agents, anti-cling agents, pH adjusters, deionized water, colorants, sequestrants, preservatives and surfactants.

16. The package of claim 11 wherein said elastomer emulsion contains an elastomer selected from the group consisting of a styrene-butadiene elastomer, an acrylic rubber elastomer, and blends thereof.

17. The package of claim 11 wherein said polymer emulsion is a styrene-acrylate emulsion.

18. The package of claim 11 wherein said plasticizer is selected from the group consisting of esters, oils and blends thereof.

19. The package of claim 14 wherein said elastomer emulsion or blend of elastomer emulsions has a combined Tg of about −28° C. to about −32° C.

20. The package of claim 14 wherein said polymer emulsion or blend of polymer emulsions has a combined Tg of about +18° C. to about +22° C.

21. The package of claim 11 wherein said transfer and anchor webs are each independently selected from a substrate composed of a material comprised of paper, polyolefin, polyester, nylon, polyvinylchloride and metalized versions of these substrates as well as metal foil.

22. The package of claim 11 wherein said transfer adhesive and said anchor adhesive have different formulations, and said transfer web and said anchor web are separate substrates each composed of a different material.

23. The package of claim 11 wherein said transfer adhesive and said anchor adhesive have substantially the same formulations, and said transfer web and said anchor web are composed of different materials.

24. The package of claim 11 wherein said transfer adhesive and said anchor adhesive have different formulations, and said transfer web and said anchor web are both part of the same substrate and composed of the same material.

25. The package of claim 11 wherein said transfer adhesive and said anchor adhesive have substantially the same formulations, and said transfer web and said anchor web are both part of the same substrate and composed of the same material.

26. The package of claim 11 further including a primer coating on the surface of either or both of said anchor web and said transfer web to enhance adhesion of said adhesive thereto.

27. The package of claim 26 wherein said primer coating comprises about 2 to 99.9% of a polymer or combination of polymers, selected from the group consisting of: styrene butadiene rubber (SBR), acrylic polymers and copolymers, ethylene vinyl acetate (EVA), ethylene methacrylic (EMA) or acrylic acid (EAA), polyethyleneimine (PEI), polyurethane (PU), silanes and silanated polymers.

28. The package of claim 11 further including a primer coating on the surface of either or both of said transfer web and said anchor web to decrease adhesion of the adhesive thereto.

29. The package of claim 28 wherein said primer coating comprises about 5 to 99% by weight of a polymer selected from the group consisting of: a high molecular weight polyethylene polymer or ethylene copolymer, SIS, SBS, SEBS, SBR, acrylics, and silicones.
